(19) United States
(12) Patent Application Publication
(10) Pub. No.: US 2017/0314432 A1
(43) Pub. Date: Nov. 2, 2017

(54) System for Reverse Crankcase Ventilation During Boosted Engine Operation

(71) Applicant: Ford Global Technologies, LLC, Dearborn, MI (US)

(72) Inventors: Rishi Dwivedi, Westland, MI (US); Todd Kappauf, Dearborn, MI (US)

(21) Appl. No.: 15/144,144

(22) Filed: May 2, 2016

(51) Int. Cl. F01M 13/02; F02M 25/06; F01M 13/00; F02B 33/00; F02M 35/10

(52) U.S. Cl. CPC F01M 13/028; F02M 35/10222; F02M 35/10157; F01M 13/0011; F02B 33/00; F02M 25/06

(57) ABSTRACT

Positive crankcase ventilation (PCV) systems have been employed on naturally-aspirated engines for over half a century. The gases in the crankcase exit the engine into the engine intake due to the slightly elevated pressure in the crankcase. Flow is controlled via a PCV valve in a PCV duct. In pressure-charged engines, PCV flow stops when pressure in the intake exceeds that of the crankcase. Such stagnation leads to sludging and deposit formation. According to an embodiment of the disclosure, reverse flow through the system is allowed by installing a second PCV valve in parallel with the normally-provided PCV valve, with the second PCV valve allowing an opposite direction of flow. Oil separators are provided on both PCV ducts to and from the engine to remove oil from blowby gases for flow in either direction.

### FIELD

The present disclosure relates to ventilating the crankcase of engines during boosted operation.

### BACKGROUND

Reciprocating, internal-combustion engines use piston rings so that combustion gases at high pressure in the cylinder do not readily escape to the crankcase. Some small fraction of the gases, less than 1% in a properly fitting piston-liner systems, does escape the combustion chamber past the rings and through the ring gaps. These gases are partially burned products of combustion that may contain unburned fuel and reactive components of partially burned fuel mixed with air. The very first emission control measure applied to automotive internal-combustion engines in the 1960s was a positive crankcase ventilation (PCV) system. Now such systems are universally employed.

In FIG. 1, an engine system 100 with a PCV system is shown on a naturally-aspirated engine 102. Engine 102 has a cylinder head 104 with a rocker arm cover (not separately shown) that covers the valvetrain components, a block 106, and an oil pan 108. Air is inducted to engine 102 via a duct 114 which has an air cleaner 110 and a throttle valve 112 that lead to an intake manifold 116. Exhaust from engine 102 into an exhaust manifold 120 into an exhaust duct 122 that exhausts into the atmosphere after passing through any muffler and emission control apparatuses in exhaust duct 122.

Valvetrain components, which are not separately shown in FIG. 1, may include camshafts, rocker arms, roller finger followers, poppet valves, and springs.

Engine 102 has a crankcase 108 into which blowby past engine rings exits. If these blowby gases were not vented, pressure would develop in the engine and would eventually find an escape route the atmosphere. As these gases venting from the crankcase account for about half of the hydrocarbon emissions from an engine that is without any emission control, clearly this is not an acceptable option. Crankcase 108 is in fluidic communication with volume within cylinder head 104 that is enclosed by a rocker arm cover. Blowby gases are drawn off through an opening in the rocker arm cover passing through a duct 130 with a PCV valve 132 disposed therein. Duct 130 fluidly connects the open space above the valvetrain components with intake duct 114 (downstream of throttle 112 and upstream of intake manifold 116). Pressure in duct 114 downstream of throttle 112 is at lower than atmospheric at almost all engine operating conditions. Thus, flow is induced via the pressure difference. PCV valve 132 controls flow through duct 130. A clean air supply duct 134 for ventilation is provided between intake duct 114 at a location upstream of throttle 112 and couples to the rocker arm cover of cylinder head 104. Duct 134 couples to cylinder head 104 at the opposite end at which duct 130 couples to flush the cylinder head with clean intake air. The PCV ducting shown in FIG. 1 is one non-limiting example.

An oil separator 136 is provided under the rocker arm cover. Blowby gases not only contain unburned hydrocarbons and corrosive components but also have oil mist that is thrown off rotating components in the crankcase and in the cylinder head that are provided pressurized lubricant. The oil contains phosphorous-containing additives that would deactivate a catalytic converter if allowed to burn in the combustion chamber. Even without the oil additives, it is preferable to keep the oil within the engine and prevent it from being inducted into the intake of the engine. Oil separator 136 is provided to extract the oil from the blowby gases prior to entering PCV valve 132 and then into intake duct 114. Oil separator 136 may use cyclone separation by swirling the air so that the small droplets hit the walls of the separator and then drip back into cylinder head 104. In some cases, oil separator 136 is a filter that collects the larger oil droplets, but allow gases to pass through. Captured oil eventually falls back into cylinder head 104. Any suitable oil separation mechanism may be employed in separator 136.

Within an internal combustion engine there are various volumes: combustion chambers that are selectively coupled via poppet valve to intake ports and exhaust ports. There is a coolant system with pressurized coolant circulating mostly through the cylinder head and the upper portions of the cylinders. There are pressurized oil supply lines. An oil pump pulls oil out of the oil pan and pressurizes oil passages within the engine that feed bearing surfaces associated with moving parts. The oil leaks, in a controlled fashion, from between bearing surfaces or maybe sprayed onto parts such as piston skirts or the underside of pistons when they are oil cooled. The oil drips down to the oil pan. There is a volume in the engine, which includes the oil pan, the crankcase, and the valvetrain area in which gases and oil exists at mostly atmospheric pressure. These volumes, which is called oil-containment volume herein, are fluidly coupled. The oil-containment volume, within this disclosure, specifically excludes the pressurized oil lines which are oil only (no more than a small of incorporated air is in the oil) and is at much higher pressure than this oil-containment volume.

In a boosted engine, such as one with a turbocharger or supercharger, pressure in duct 114 is often higher than pressure in crankcase 108. In such a case, the flow would reverse, except the PCV valve 132 does have a shutoff that prevents reverse flow. If the boosted operation were momentary, the PCV system of the prior art would be suitable. However, the more drastic the downsizing/boosting of the engine, the greater the fraction of time that the engine spends in at a boosted condition, approaching 50% of the duty cycle of the engine in some cases. The problem that ensues is that without proper ventilation, sludge forms in the engine oil because of the higher contact with the corrosive byproducts of combustion. Sludge is a problem in its own right and also leads to varnish and deposits forming on engine components, e.g, the back of poppet valves, which degrades engine breathing (performance) and acts as an insulator on valves causing valve overheating and/or engine knock. Also, unburned fuel in the blowby dilutes the oil thereby reducing the oil's lubricating properties. Reverse flow cannot be allowed to occur as the oil laden blowby would be inducted into the engine and cause deposit problems in the engine as well as foul the catalyst with phosphorous from oil additives.

### SUMMARY

To overcome at least one problem in the prior art, a PCV valve system that allows reverse flow is disclosed. The engine has a cylinder block coupled to a cylinder head and an engine intake with a compressor and a throttle valve disposed therein. A first PCV duct fluidly couples an oil-containment volume within the engine and the engine intake downstream of the compressor. A PCV valve is disposed in the first PCV duct. The PCV valve allows flow when pressure in the engine intake is higher than pressure in the oil-containment volume. A second PCV duct fluidly coupling the engine intake upstream of the throttle valve and the oil-containment volume. The system further includes an oil separator fluidly coupled to the second PCV duct. The oil separator is located within the oil-containment volume.

The cylinder block comprises a crankcase which has an oil pan coupled thereto. The cylinder head houses a valvetrain with a cover sealing the valvetrain volume. The oil-containment volume comprises volume within the crankcase, the oil pan, and the valvetrain in which oil and gases are housed.

In some embodiments, the system further includes a third PCV duct fluidly coupling the an oil-containment volume within the engine and the engine intake downstream of the compressor and a second PCV valve disposed in the third PCV duct wherein the second PCV valve duct that allows flow when pressure in the engine intake lower than pressure in the oil-containment volume.

The system further includes an oil separator fluidly coupled to the second PCV duct and located within the oil-containment volume.

The PCV valve includes a housing defining an inlet and an outlet, a pintle valve with a taper that engages with the outlet, and a spring biasing the pintle valve toward the inlet.

In an alternative embodiment, the valve has a housing defining a first opening and a second opening, a pintle valve having a first taper on a first end that engages with the first opening and a second taper on a second end that engages with the second opening, a first spring biasing the pintle toward the first end; and a second spring biasing the pintle toward the second end.

Also disclosed is a ventilation system for an engine with an engine intake with a compressor disposed therein; a valve disposed in a first ventilation duct, which couples the engine intake downstream of the compressor with an oil-containment volume of the engine; and a second ventilation duct fluidly coupling the engine intake upstream of the compressor and the oil-containment volume. The valve closes when pressure in the oil-containment volume is higher than intake manifold pressure. The system has an oil separator disposed within the oil-containment volume and fluidly coupled to the second ventilation duct.

The first ventilation duct couples to the oil-containment volume of the engine at a location distal from the location where the second ventilation duct couples to the oil-containment volume.

The system may have both a first oil separator disposed within the oil-containment volume and fluidly coupled to the first ventilation duct and a second oil separator disposed within the oil-containment volume and fluidly coupled to the second ventilation duct. The first oil separator is displaced from the second oil separator such that gases in the oil-containment volume are thereby ventilated.

The oil-containment volume comprises volumes within the engine in which unpressurized oil and gases reside including an oil pan, a crankcase, and a cylinder head coupled to the engine.

Also disclosed is PCV system for an engine having an engine intake with a compressor disposed in the intake. A first duct with a valve disposed therein couples the engine intake downstream of the compressor with an oil-containment volume of the engine and a second duct coupling the oil-containment volume and the engine intake upstream of the compressor wherein the valve allows flow when pressure in the intake manifold exceeds pressure in the oil-containment volume.

The system may further include a first oil separator disposed within the oil-containment volume and fluidly coupled to the first ventilation duct and a second oil separator disposed within the oil-containment volume and fluidly coupled to the second ventilation duct. The first oil separator is displaced from the second oil separator such that gases in the oil-containment volume are thereby ventilated when there is flow through the first and second ventilation ducts.

The valve has a valve body having a first opening on a first end and a second opening on a second end; a pintle disposed within the body, the pintle having a first taper on a first end of the pintle that engages with the first opening and a second taper on a second end of the pintle that engages with the second opening; a first spring that biases the pintle toward the first end of the valve body; and a second spring that biases the pintle toward the second end of the valve body.

Some embodiments include a third ventilation duct which couples the engine intake downstream of the compressor with an oil-containment volume of the engine and a second valve disposed in the third ventilation duct wherein the second valve closes when pressure in the oil-containment volume is lower than intake manifold pressure.

The engine intake also has a throttle valve disposed therein and located upstream of the compressor. The first second duct couples to the engine intake upstream of the throttle valve.

In embodiments in which the engine has a vee configuration with first and second cylinder heads, the first ventilation duct couples to the first cylinder head at a first end of the engine and the second ventilation duct couples to the second cylinder head at a second end of the engine.

### BRIEF DESCRIPTION OF THE DRAWINGS

FIGS. 1 and 5 are illustrations of prior art PCV systems system for naturally-aspirated in-line and vee engines, respectively;

FIGS. 2 and 6 are illustrations of turbocharged in-line and vee engines, respectively, having PCV systems according to embodiments of the present invention;

FIGS. 3 and 4 are PCV valve shown in cross section.

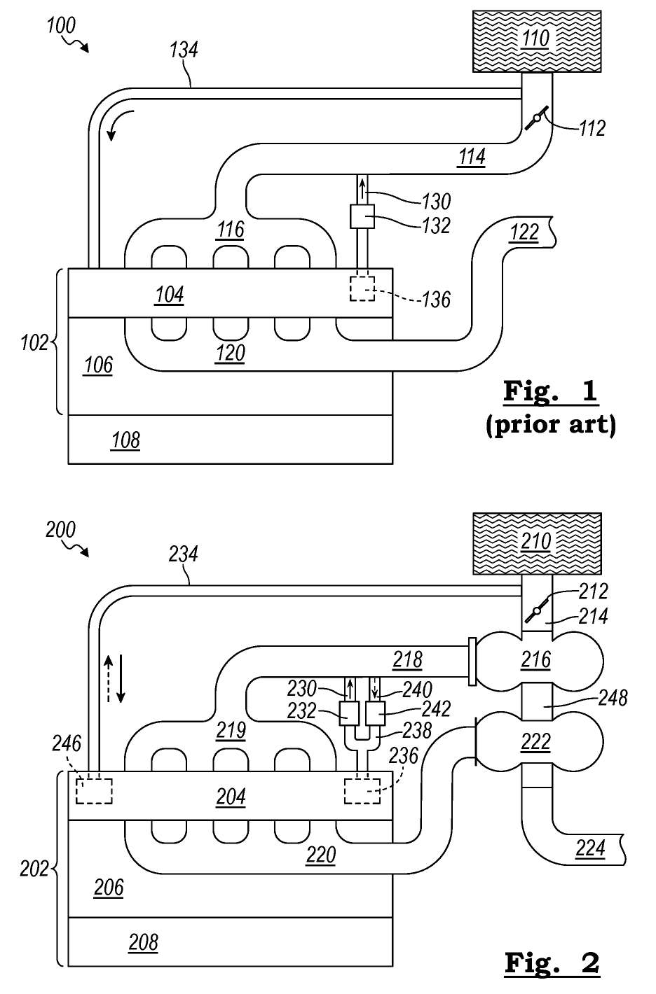

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

One embodiment of a PCV system for an in-line, pressure-charge engine is shown in FIG. 2. An engine system 200 has an internal combustion engine 200 that has a cylinder head 204 coupled to an engine block 206 that has an oil pan coupled to block 208. The crankcase is at the bottom of engine block 206 and is covered by oil pan 208. Intake air is provided to engine 202 via an intake duct 218 into which an air cleaner 210, a throttle valve 212, and a compressor 216 are disposed. Exhaust leaves engine 202 via an intake manifold 220 through an exhaust duct 224 that has a turbine 222 disposed in exhaust duct 224. Compressor 216 and turbine 222 are coupled to a shaft 248 forming a turbocharger. Energy in the exhaust gases drive turbine 222 which in turn drives compressor 216 to thereby pressurize the intake gases so that more work can be developed in engine 202. The present disclosure also applies to engine with superchargers in which there is no turbine in the exhaust. The compressor in the intake is typically driven off the crankshaft of the engine via a transmission.

A conventional PCV system is provided for providing ventilation when the pressure in the oil-containment volume of engine 202 is greater than the pressure in intake duct 218 (downstream of compressor 216). Such PCV system includes a first duct 230 that couples intake duct 218 with cylinder head 204 (in the oil-containment volume in cylinder head 204). A PCV valve is placed in first duct 230. In the embodiment in FIG. 2, a part of the PCV duct that couples the two is part of a Y-duct 238 that is explained more completely below. A second PCV duct 234 couples the oil-containment volume in cylinder head 204 with intake duct 218 at a location upstream of throttle valve 212. An oil separator 236 is housed within the oil-containment volume in cylinder head 204. Oil separator 236 filters out oil droplets in gases in the oil-containment volume and returns them to the oil-containment volume, but lets the gases from the oil-containment volume pass through PCV valve 230. The solid arrow in duct 230 and near duct 200 indicate the direction of flow in the normal PCV operation.

The embodiment in FIG. 2 also includes a reverse-flow PCV system. A second PCV duct 240 with a second PCV valve 242 provided therein couples intake duct 218 (at a location downstream of compressor 216) with the oil-containment volume within engine 202. Part of the second duct is made up of Y-pipe 238. Flow in the reverse PCV system moves in the direction shown by the dashed arrows shown near duct 234 and in 240. An oil separator 246 is provided within the oil-containment volume in cylinder head 240 to remove oil mist and droplets from the gases moving into duct 234.

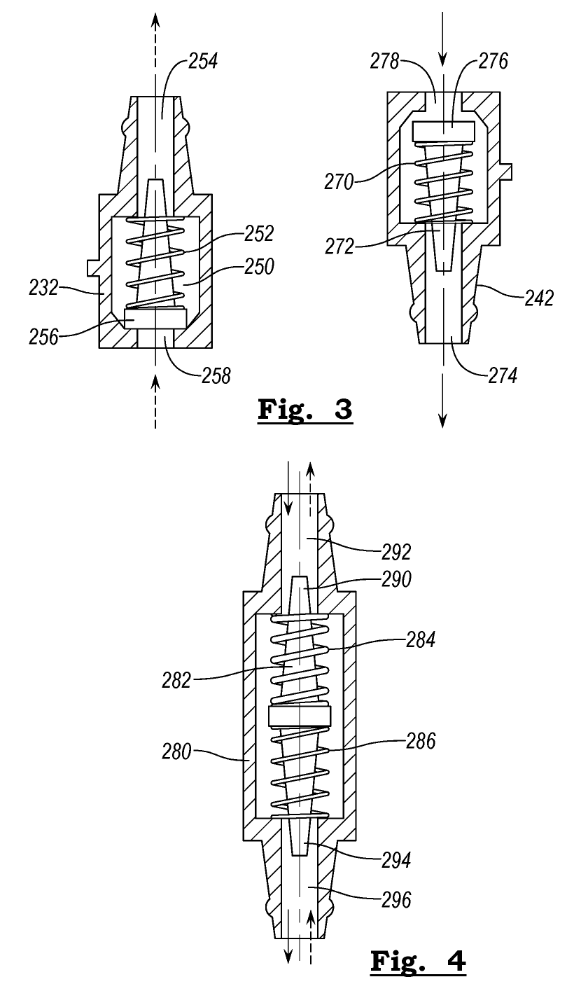

PCV valves 232 and 242 are shown in cross-section and in greater detail in FIG. 3. A housing of PCV valve 234 defines an inlet 258 and an outlet 254. A pintle 256 has a squared off end proximate inlet 258. When pressure is higher at outlet 254 than at inlet 258, the squared off end of pintle 256 closes off inlet 258. When pressure is higher at inlet 258, pintle 256 moves toward outlet 254 thereby popping pintle 256 off inlet 258 and allowing flow through valve 234. A spring 252 biases pintle 256 toward inlet 258. As pressure at inlet 258 exceeds pressure at outlet 254 by an even greater degree, a tapered end of pintle 256 is pushed into outlet 254 and closes off the flow area, thereby controlling flow. PCV valve 242 is similar to PCV valve 232 except that it is an opposite direction. Desired flow characteristics of valve 242 may be different than that of valve 232 in which case, the taper of a pintle 276, the taper of an outlet of outlet 274, and spring tension of a spring 270 that biases pintle 276 toward inlet 278 can all be adjusted to provide such desired characteristics. Valve 232 is shown in a closed position in which inlet 258 is occluded preventing flow through valve 232. Pintle 276 of valve 242 is shown lifted off the seat in the body of the valve so that flow can pass by pintle 276 through valve 242.

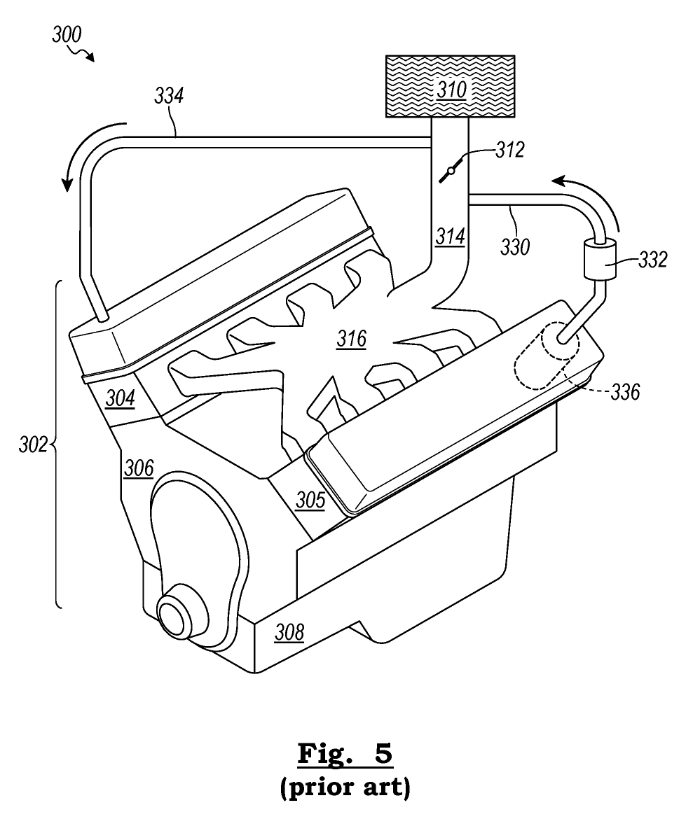

The embodiment in FIG. 2 has two PCV valves 232 and 242 with more detail on valves 232 and 242 shown in FIG. 3. However, in an alternative in FIG. 4, a two-ended PCV 280 valve is provided in place of PCV valves 232 and 242. Valve 280 can control flow in either of the situations where the pressure is higher at a first end than the second end or where the pressure is lower at the first end than the second end. Such a PCV valve 280 has a body that defines a first opening 292 and a tapered opening 296. A pintle 282 has a first tapered end 290 that engages with opening 292 and a second tapered end 294 that engages with opening 296. The tapers 290 and 294 can be selected to provide the desired flow characteristics in the forward (solid arrows) and reverse (dashed arrows) flow directions. A first spring 284 in valve 280 biases pintle 282 toward second opening 296 and a second spring 286 in valve 280 biases pintle 282 toward first opening 292. Spring 284 is a stiffer spring than spring 286 in the embodiment in FIG. 4.

Valves 232, 242, and 280 show a tapered pintle with cylindrical openings. In alternative embodiments, the pintle ends could be cylindrical with openings 254, 258, 274, 278, 292, and 296 in the bodies of valve 232, 242, and 280 being tapered. In even another embodiment, both the openings 254, 258, 274, 278, 292, and 296 and pintle ends are tapered, possibly with different taper angles so that the pintles move a great distance to provide a modest change in open area. This would provide very fine control of flow.

A prior art PCV valve system is shown for a naturally-aspirated engine system 300 in FIG. 5. Engine 302 has a block 306 with an oil pan 308. Block 306 has two cylinder banks and thus two cylinder heads 304 and 305. Air is provided through air cleaner 320 into an intake duct 314 which has a throttle valve 312 therein and into an intake manifold 316. A PCV system has a first duct 330 into which a PCV valve 332 is disposed and a second duct 334. An oil separator 336 provided in the oil-containment volume within cylinder head 305 is fluidly coupled to one end of PCV duct 330 to remove oil mist before the gases are introduced into intake duct 314. As described above in regards to an in-line engine, there is what is called herein as an oil-containment volume that is made up of volumes in the oil pan, the crankcase, and in the case of a vee engine, both cylinder heads 304 and 305, specifically the volumes in which the valvetrains reside and specifically does not include the combustion chambers or any coolant volumes or pressurized oil passages. These volumes are in fluidic communication. To provide a true ventilation system where gases are pushed through the system, fresh air flows through duct 334 into cylinder head 304 at one end. Flow continues into oil pan 308 and then out of cylinder head 305 at the other end. The inlet and outlet for the ventilation system are purposely separated from each other.

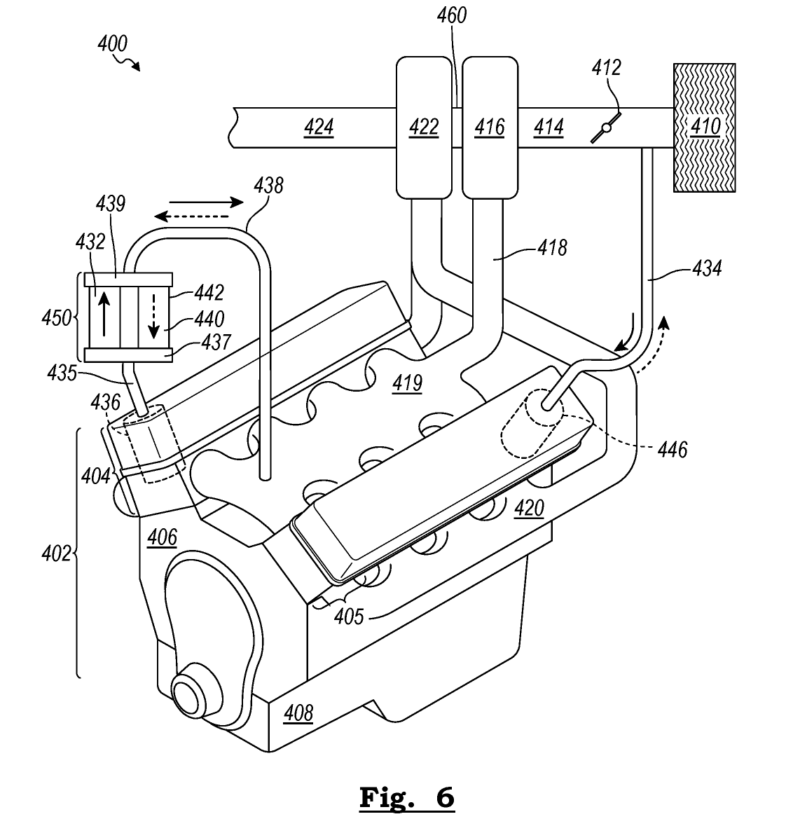

A disclosed embodiment of a PCV system for a pressure-charged engine system 400 is shown in FIG. 6. Engine 402 is a vee engine having an oil pan 408 coupled to a cylinder block 406 onto which two cylinder heads 404 and 405 are coupled. Air is provided to engine 402 via an air induction system that includes air cleaner 410, a throttle valve 412 that controls flow of air through air intake duct 414 that is upstream of compressor 416. Compressor 416 provides air into duct 418 that leads to intake manifold 419. Engine 402 exhaust products of combustion into an exhaust manifold 420 into turbine 422, which exhausts into exhaust duct 424. In the forward-flow, or normal operation, gases and oil mist from within the engine (called oil-containment volume) that are mostly generated by blowby are provided into an oil separator 436 that leads to a PCV duct 435 that leads to following, in succession: a collector 437, a PVC valve 432, a collector 439, a PCV duct 438, and intake manifold 419. Alternatively, PCV flow could be provided upstream of intake manifold 419. To provide fresh air to make up for the gases drawn out through PCV valve 432, a fresh air duct 434 fluidly couples intake duct 414 upstream of throttle valve 412 with oil-containment volume within engine 402. Normal or forward PCV flow occurs when pressure in the oil-containment volume within engine 402 is greater than pressure in intake manifold 419 (or in intake duct 418).

When pressure in the oil-containment volume with engine 402 is less than pressure intake manifold 419, reverse PCV flow is induced. Gases from intake manifold 419 flow into PCV duct 438, into collector 439, through a PCV valve 440, into collector 437, into PCV duct 436, into oil collector 436, and into oil-containment volume in engine 402. The gases are vented out through oil separator 446, PCV duct 434 and on into intake duct 414 upstream of throttle valve 412.

Collector 436 is an alternative to Y-pipe 236 in FIG. 2. Collector 439 is an alternative to pipe 230 and 240 in FIG. 2. Depending on packaging and cost, one alternative may be found preferable over another. Another option is double PCV valve 280 that obviates collectors 437 and 439 as well as PCV valve 432 and 440.

To ventilate, the path through which the gases flow through the engine are made nearly as long as possible. Thus, the inlet and outlet are on opposite banks and opposite ends of the two banks.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A positive crankcase ventilation (PCV) system for an internal-combustion engine having: a cylinder block coupled to a cylinder head and an engine intake with a compressor and a throttle valve disposed therein, comprising:
a first PCV duct fluidly coupling an oil-containment volume within the engine and the engine intake downstream of the compressor;
a PCV valve disposed in the first PCV duct that allows flow when pressure in the engine intake is higher than pressure in the oil-containment volume; and
a second PCV duct fluidly coupling the engine intake upstream of the throttle valve and the oil-containment volume.

2. The PCV system of claim 1, further comprising: an oil separator fluidly coupled to the second PCV duct.

3. The PCV system of claim 2 wherein the oil separator is located within the oil-containment volume.

4. The PCV system of claim 2 wherein the cylinder block comprises a crankcase; the crankcase has an oil pan coupled thereto; the cylinder head houses a valvetrain with a cover sealing the valvetrain volume; the oil-containment volume comprises volume within the crankcase, the oil pan, and the valvetrain in which oil and gases are housed.

5. The PCV system of claim 1 wherein the PCV valve in the first PCV duct is a first PCV valve, the PCV system further comprising:
a third PCV duct fluidly coupling the an oil-containment volume within the engine and the engine intake downstream of the compressor; and
a second PCV valve disposed in the third PCV duct wherein the second PCV valve duct that allows flow when pressure in the engine intake lower than pressure in the oil-containment volume.

6. The PCV system of claim 1, further comprising: an oil separator fluidly coupled to the second PCV duct and located within the oil-containment volume.

7. The PCV system of claim 1 wherein the PCV valve comprises: a housing defining an inlet and an outlet, a pintle valve with a taper that engages with the outlet, and a spring biasing the pintle valve toward the inlet.

8. The PCV system of claim 1 wherein the PCV valve comprises:
a housing defining a first opening and a second opening;
a pintle valve having a first taper on a first end that engages with the first opening and a second taper on a second end that engages with the second opening;
a first spring biasing the pintle toward the first end; and
a second spring biasing the pintle toward the second end.

9. A ventilation system for an engine, comprising:
an engine intake with a compressor disposed therein;
a valve disposed in a first ventilation duct, which couples the engine intake downstream of the compressor with an oil-containment volume of the engine; and
a second ventilation duct fluidly coupling the engine intake upstream of the compressor and the oil-containment volume, wherein the valve closes when pressure in the oil-containment volume is higher than intake manifold pressure.

10. The ventilation system of claim 9, further comprising:
an oil separator disposed within the oil-containment volume and fluidly coupled to the second ventilation duct.

11. The ventilation system of claim 9 wherein the first ventilation duct couples to the oil-containment volume of the engine at a location distal from the location where the second ventilation duct couples to the oil-containment volume.

12. The ventilation system of claim 9, further comprising:
a first oil separator disposed within the oil-containment volume and fluidly coupled to the first ventilation duct; and
a second oil separator disposed within the oil-containment volume and fluidly coupled to the second ventilation duct wherein the first oil separator is displaced from the second oil separator such that gases in the oil-containment volume are thereby ventilated.

13. The ventilation system of claim 9 wherein the valve in the first ventilation duct is a first valve, further comprising:
a third ventilation duct which couples the engine intake downstream of the compressor with an oil-containment volume of the engine; and
a second valve disposed in the third ventilation duct wherein the valve closes when pressure in the oil-containment volume is lower than intake manifold pressure.

14. The ventilation system of claim 9 wherein the oil-containment volume comprises volumes within the engine in which unpressurized oil and gases reside including an oil pan, a crankcase, and a cylinder head coupled to the engine.

15. A ventilation system for an engine, comprising:
an engine intake having a compressor disposed therein;
a first duct with a valve disposed therein, the duct coupling the engine intake downstream of the compressor with an oil-containment volume of the engine; and
a second duct coupling the oil-containment volume and the engine intake upstream of the compressor wherein the valve allows flow when pressure in the intake manifold exceeds pressure in the oil-containment volume.

16. The system of claim 15, further comprising:
a first oil separator disposed within the oil-containment volume and fluidly coupled to the first ventilation duct; and
a second oil separator disposed within the oil-containment volume and fluidly coupled to the second ventilation duct wherein the first oil separator is displaced from the second oil separator such that gases in the oil-containment volume are thereby ventilated when there is flow through the first and second ventilation ducts.

17. The system of claim 15 wherein the valve comprises:
a valve body having a first opening on a first end and a second opening on a second end;
a pintle disposed within the body, the pintle having a first taper on a first end of the pintle that engages with the first opening and a second taper on a second end of the pintle that engages with the second opening;
a first spring that biases the pintle toward the first end of the valve body; and
a second spring that biases the pintle toward the second end of the valve body.

18. The system of claim 15, further comprising:
a third ventilation duct which couples the engine intake downstream of the compressor with an oil-containment volume of the engine; and
a second valve disposed in the third ventilation duct wherein the second valve closes when pressure in the oil-containment volume is lower than intake manifold pressure.

19. The system of claim 15 wherein:
the engine intake also has a throttle valve disposed therein and located upstream of the compressor; and
the first second duct couples to the engine intake upstream of the throttle valve.

20. The system of claim 15 wherein:
the engine is a vee configuration having first and second cylinder heads;
the first ventilation duct couples to the first cylinder head at a first end of the engine; and
the second ventilation duct couples to the second cylinder head at a second end of the engine.
